(19) United States
(12) Patent Application Publication
(10) Pub. No.: US 2003/0108644 A1
(43) Pub. Date: Jun. 12, 2003

(54) Tongue colors

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 10/003,182

(22) Filed: Dec. 6, 2001

(51) Int. Cl. A23G 1/00

(52) U.S. Cl. 426/134

(57) ABSTRACT

A tongue coloring device including a candy pop holder in which the candy pop comprises non-toxic dye of different colors so that when consumed, the tongue will become the same color as the non-toxic dye. The candy pop can be secured onto the pop holder by a candy pop stick or by a nipple on the upper end of the pop holder. The device can include a power source which when activated, activates a lamp which shines a light from the housing. The device can also include a marking cartridge which has a tip such that when the cartridge is pushed with the tip end out of the housing, the device can be used for marking something of the color contained in the cartridge.

### BACKGROUND OF THE INVENTION

This invention is directed to an invention set forth in a disclosure document filed in the U.S. Patent and Trademark Office on or about Nov. 13, 2000.

This invention is directed to a device which holds a piece of candy for consumption and more particularly to a candy holding device including a type of candy containing non-toxic dyes which will color a user's tongue different colors.

### PRIOR ART

The inventors have patented several different devices for holding a candy lollipop for consumption. These devices are made for the pleasure of a user.

### SUMMARY OF THE INVENTION

An object of the invention is to provide a candy designed to add colors to one's tongue during consumption.

Another object is to provide a candy device which provides pleasure to a person without any harmful effects.

Yet another object is to provide a candy device designed to add different colors on one's tongue during use in combination with other devices which add additional pleasure beyond consumption of the candy.

An advantage of the device is to add enjoyment to consumption of a piece of candy.

Another object is to add a further type of enjoyment beyond that of consumption of a piece of candy.

Other objects and advantages of the invention will become obvious to those skilled in the art upon a review of the drawings, specification and claims.

### BRIEF DESCRIPTION OF THE DRAWINGS

FIG. 1 illustrates a side view of the tongue colors device having a replaceable piece of candy on a stick;

FIG. 2 illustrates a device similar to FIG. 1 which includes a piece of candy molded onto an end of the device;

FIG. 4 illustrates a device as set forth in FIG. 1 to which a LED light has been added; and

FIG. 5 illustrates a device having a longitudinal slot in which a slide button functions to lift a device having a marking tip which can be used to color one's tongue or any other object to be colored.

### DETAILED DESCRIPTION OF THE INVENTION

Now referring to the drawings, where like references will refer to the like parts through the different views, FIG. 1 illustrates a device including a main housing 10 having a removable upper end 12 which may be screwed on or pressed on with a tight fit or by any other means. The upper end includes an anchor 14 to which a short chain 16 is secured. A clasp or hook 18 is secured to the loose end of the chain. A lollipop 20 is shown secured to a stick 22 having an end shown in dotted lines that is secured within an aperture 24 in the upper end of the housing so that the lollipop can be replaced.

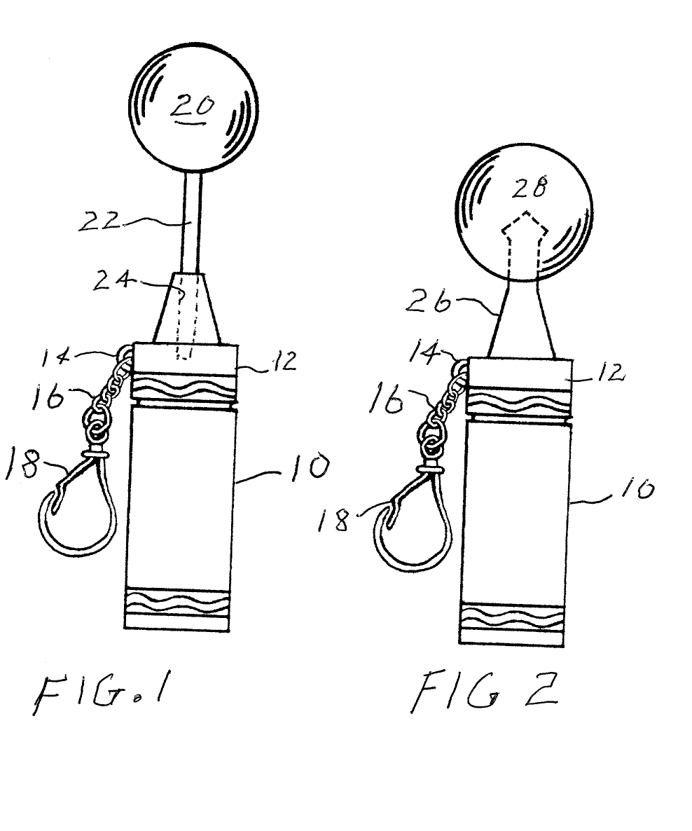

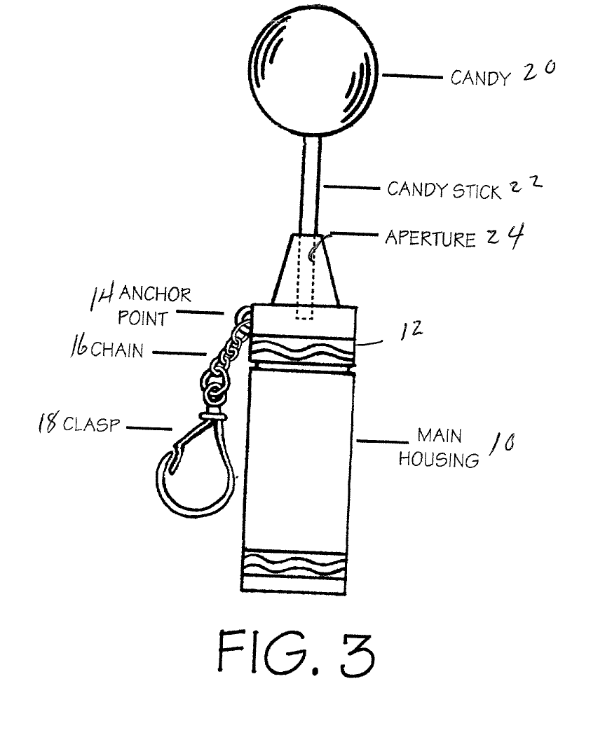

FIG. 2 is the same as shown in FIG. 1 except that the upper end provides a nipple 26 to which a piece of candy 28 is secured. The nipple could be provided with an aperture such that after the piece of candy on the nipple has been consumed, a lollipop on a stick could be secured to the housing for consumption.

The housing can be made of any desired material such as plastic and could have markings such as a crayon so that the housing resembles a crayon. For sanitary reasons the lollipop should have at least a paper covering such as usually found on a lollipop. The covering could be replaced onto the lollipop if only a portion is consumed so that the remaining portion could be protected.

In addition to a housing 28 with a lollipop secured thereto, one or more batteries 30 could be secured in the main housing as an electrical source to operate a light such as shown in FIG. 3. The light could be a regular flashlight bulb or an LED bulb 32. A switch 34 can be provided for operation of the light. The housing is shown with an aperture 36 in the bottom through which the light from the LED would shine.

FIG. 5 is shown with a main housing 28 having a longitudinal slot 42 with a marking color cartridge 44 having a marking tip 46 on its upper ends A slide button 48 is secured to the lower end of the cartridge which is provided to move the cartridge upwardly so that the tip will be exposed. The marking tip could be used after the lollipop has been consumed and the stick removed. Thus, the cartridge could be moved upwardly to extend out of the end of the upper housing so that the tip can be used to color whatever is desired to color.

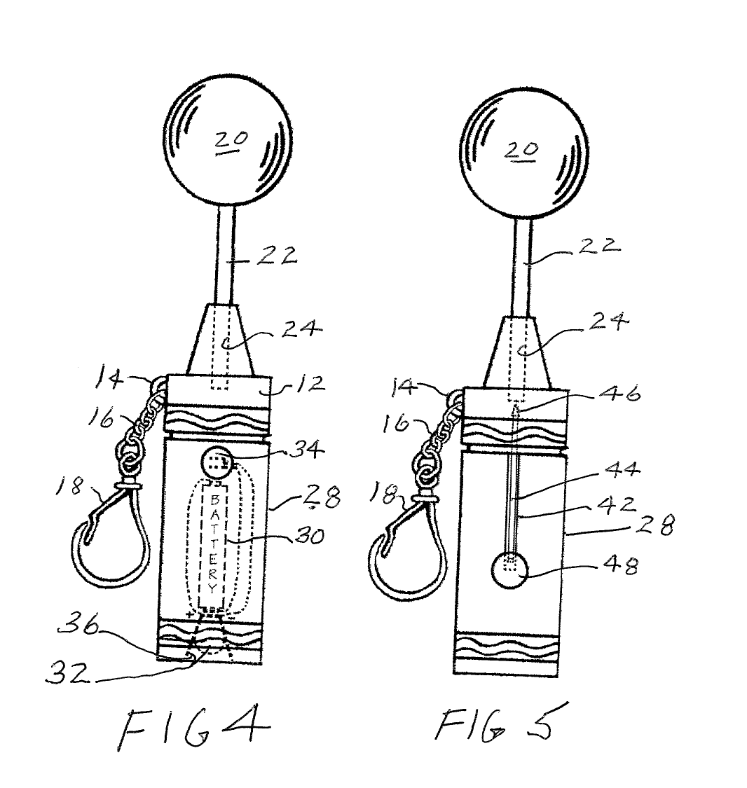

A cartridge and slide can be added to the light source and light bulb, if desired. Each of the figures is shown with a clamp chain and clasp such as set forth in FIGS. 1 and 2. The clasp can be used for securing the device to one's clothing for carrying the color device around without consuming the candy. From a teaching of FIGS. 1 and 2, one skilled in the art could add the features shown in FIG. 4 and/or FIG. 5 to either of the devices of FIGS. 1 and/or 2 without parting from the teaching of the prevent invention.

The foregoing relates to preferred exemplary embodiments of the invention, it being understood that other variants and embodiments thereof are possible within the spirit and scope of the invention, the latter being defined by the appended claims.

We claim:

1. A tongue color device comprising
a main housing (10, 12),
a lollipop secured to an upper end of the body,
the lollipop comprising candy with different colors of non-toxic dyes which will color a person's tongue with different colors during consumption.

2. A tongue color device as set forth in claim 1, in which said housing includes a main portion and an upper portions

3. A tongue color device as set forth in claim 2, in which said upper portion of said housing has a nipple to which the lollipop is molded.

4. A tongue color device as set forth in claim 3, in which said nipple has an aperture therein.

5. A tongue color device as set forth in claim 3, in which said upper portion of said housing is removable.

6. A tongue color device as set forth in claim 2, in which said upper portion (12) of said housing includes an aperture therein, and
a lollipop on a stick is secured to said upper portion by insertion of said stick into said aperture.

7. A tongue color device as set forth in claim 6, in which said upper portion of said housing is removable.

8. A tongue color device as set forth in claim 5, in which
said main housing includes at least one battery therein,
said at least one battery supplies a source of power to operate a light bulb, and
a switch for controlling the source of power to the light bulb.

9. A tongue color device as set forth in claim 6, in which
said main housing includes at least one battery therein,
said at least one battery supplies a source of power to operate a light bulb, and
a switch for controlling the source of power to the light bulb.

10. A tongue color device as set forth in claim 7, in which
said main housing includes at least one battery therein,
said at least one battery supplies a source of power to operate a light bulb, and
a switch for controlling the source of power to the light bulb.

11. A tongue color device as set forth in claim 5, in which
said main housing includes a longitudinal slot therein,
a coloring cartridge in said main housing in alignment with the slot, and
a button secured to a lower end of the coloring cartridge for sliding the cartridges upward out of the upper housing through the aperture therein.

12. A tongue color device as set forth in claim 7, in which
said main housing includes a longitudinal slot therein,
a coloring cartridge in said main housing in alignment with the slot, and
a button secured to a lower end of the coloring cartridge for sliding the cartridges upward out of the upper housing through the aperture therein.

13. A tongue color device as set forth in claim 8, in which
said main housing includes a longitudinal slot therein,
a coloring cartridge in said main housing in alignment with the slot, and
a button secured to a lower end of the coloring cartridge for sliding the cartridges upward out of the upper housing through the aperture therein.

14. A tongue color device as set forth in claim 9, in which
said main housing includes a longitudinal slot therein,
a coloring cartridge in said main housing in alignment with the slot, and
a button secured to a lower end of the coloring cartridge for sliding the cartridges upward out of the upper housing through the aperture therein.

15. A tongue color device as set forth in claim 10, in which
said main housing includes a longitudinal slot therein,
a coloring cartridge in said main housing in alignment with the slot, and
a button secured to a lower end of the coloring cartridge for sliding the cartridges upward out of the upper housing through the aperture therein.

16. A tongue color device as set forth in claim 2, which includes
a clasp secured to the upper portion,
a chain connected to the clasp, and
a clasp secured to the chain.

17. A tongue color device as set forth in claim 3, which includes
a clasp secured to the upper portion,
a chain connected to the clasp, and
a clasp secured to the chain.

18. A tongue color device as set forth in claim 5, which includes
a clasp secured to the upper portion,
a chain connected to the clasp, and
a clasp secured to the chain.

19. A tongue color device as set forth in claim 7, which includes
a clasp secured to the upper portion,
a chain connected to the clasp, and
a clasp secured to the chain.

20. A tongue color device as set forth in claim 8, which includes
a clasp secured to the upper portion,
a chain connected to the clasp, and
a clasp secured to the chain.
